(19) United States
(12) Patent Application Publication
(10) Pub. No.: US 2008/0276611 A1
(43) Pub. Date: Nov. 13, 2008

(54) Passive Hydraulic Controller With Positional Correction by Means of a Directionally-Controlled Exchange of Oil

(75) Inventors: Anton Gaile, Leutkirch (DE); Thomas Kuchler, Meerbusch (DE); Gerhard Schmidt, Essen (DE)

Correspondence Address: HARNESS, DICKEY & PIERCE, P.L.C., P.O. BOX 8910, RESTON, VA, 20195, US

(73) Assignee: ZUMTOBEL LIGHTING GMBH, DORNBIRN (AU)

(21) Appl. No.: 11/921,756

(22) PCT Filed: Mar. 22, 2006
(86) PCT No.: PCT/EP2006/060934

§ 371 Date: Dec. 7, 2007

(30) Foreign Application Priority Data
Jun. 9, 2005 (DE) 10-2005026697.5

(51) Int. Cl. F15B 7/10

(52) U.S. Cl. 60/545; 60/561

(57) ABSTRACT

A passive hydraulic controller is disclosed, in which the volumes V₁ and V₂ at the two sides of the piston of two or more hydraulic cylinders in each case are connected to one another hydraulically, so that a displacement of the piston in one of the cylinders results in a displacement of the piston in at least one of the other cylinders (follow-up control). The sum of all the piston travels Δs=k₁s₁+k₂s₂+ . . . +kₙsₙ in hydraulic controllers of said type should ideally always be Δs=0=const, with the proportionality factors k₁; k₂ . . . kₙ representing the reciprocal of the piston surfaces of the cylinder, and their signs being dependent on whether the connecting lines between the hydraulic cylinders are crossed or not. Passive hydraulic controllers of the generic type are, however, not positionally stable over time (Δs≠O≠const), in particular under the action of static basic loads. A varying positional error Δs must be taken into consideration, the varying positional error Δs being corrected according to the invention in that in each case when the positional error Δs exceeds a positive positional error limit +Δs which is to be defined, or falls below a negative positional error limit −Δs which is to be defined, a connection is produced between the two volumes V₁ und V₂ for the purpose of exchanging hydraulic fluid between the two volumes, in that the connection always permits the exchange of hydraulic fluid in only one direction which is determined as a function of the sign of the positional error Δs.

### PRIORITY STATEMENT

This application is the national phase under 35 U.S.C. § 371 of PCT International Application No. PCT/EP2006/060934 which has an International filing date of Mar. 22, 2006, which designated the United States of America and which claims priority on German Patent application 10 2005 026 697.5 filed Jun. 9, 2005, the entire contents of which are hereby incorporated herein by reference.

### FIELD

At least one embodiment of the invention generally relates to a passive hydraulic control, in which two or more hydraulic cylinders are connected hydraulically to one another so that a displacement of the piston in one of the cylinders results in a displacement of the piston in at least one of the other cylinders (follow-up control).

### BACKGROUND

FIG. 1 illustrates the basic principle of such a passive hydraulic follow-up control. The hydraulic cylinders 1 are connected to one another via the hydraulic lines 2. If, for example, the piston of the upper cylinder 1 in FIG. 1 is displaced by an amount of a travel s₁, then, on account of the volume constancy of V₁ and V₂, piston travels s₂ . . . sₙ on the other cylinders 1 must arise, which correspond in their sum to the travel s₁ but with an opposite sign. An equation for this situation may be written as follows:

s₁=−(s₂+ . . . +sₙ). (1)

This situation described by equation 1 applies when all the hydraulic cylinders 1 have piston areas of identical size. If hydraulic cylinders 1 with piston areas of different size are used, differentiated travels from the individual hydraulic cylinders 1 can be implemented. The travel linkage can them be illustrated by equation 2:

0=k₁s₁+k₂s₂+ . . . +kₙsₙ. (2)

In this equation, k₁ . . . kₙ represent proportionality factors which are themselves inversely proportional to the piston areas A₁ . . . Aₙ of the hydraulic cylinders:

$${k}_{1} : {k}_{2} : … : {k}_{n} = \frac{1}{{A}_{1}} : \frac{1}{{A}_{2}} : … : \frac{1}{{A}_{n}} . \qquad ( 3 )$$

Some of the proportionality factors k₁ . . . kₙ may also assume negative values, for example, when the hydraulic lines 2 are crossed (according to the example shown in FIG. 11).

The passive hydraulic controls described are often used advantageously instead of control rod assemblies when relatively high actuating forces have to be transmitted over long distances and, if appropriate, complicated force deflections and/or force step-ups by way of levers would be required. Even force transmission beyond the limits of machine or apparatus sections moving in relation to one another, for example, via vehicle joints, can, as a rule, be achieved more advantageously by hydraulic devices than by a mechanism. Examples of typical applications of a passive hydraulic control having the abovementioned properties are:
the joint control for the railcar joint of a two-part articulated railcar according to the publication DE 21 23 876 A1,
the axle controls for rail vehicles, such as are described in the publications DE 31 23 858 A1, DE 33 31 559 A1 or DE 43 43 608 A1,
the hydraulic rotary angle coupling, described in publication EP 0 755 839 A2, of running gears of multiple-unit rail vehicles, or
the running gear and joint controls, such as are described in publications DE 299 13 547 U1, EP 1 074 448 A1, EP 1 074 449 A1 or DE 100 12 966 A1.

Passive hydraulic controls operating on the principle described require, in addition to the hydraulic cylinders 1 and the connecting lines 2, further structural elements for reliable functioning. These are shown by way of example, in their basic arrangement, in FIG. 2 for a system with two hydraulic cylinders 1. So that losses of hydraulic fluid which are caused by leaks in the system can be compensated, a hydraulic accumulator 5 is provided. This can supplement hydraulic fluid possibly absent in the volumes V₁ and V₂ via the nonreturn valves 6. A volume contraction of the hydraulic fluid, caused by a lowering of temperature, is also compensated in this way from the hydraulic accumulator 5. Too high a pressure in the hydraulic system, which may also be caused by the expansion of the hydraulic fluid in the event of a rise in temperature, is prevented by the pressure limiting valves 7, in that, in such an instance, hydraulic fluid can escape via these from the volumes V₁ and V₂ into the hydraulic accumulator 5.

In the passive hydraulic controls of the generic type, it must be assumed that, without appropriate correcting measures, they are not positionally stable for lengthy periods of time. The piston travel linkages described by equation 1 or equation 2 cannot be ensured permanently. This is caused, inter alia, by leakages, for example in the form of the overflow of hydraulic fluid from V₁ toward V₂, or vice versa, via the cylinder piston seal. Afterfeed or feedback from or to the hydraulic accumulator 5 also does not take place in a synchronized manner for V₁ and V₂ and therefore are detrimental to the permanent volume constancy for V₁ and V₂.

The travel linkage for the pistons of the hydraulic cylinders would therefore have to be described, instead of by way of equation 2, by the following equation 4:

Δs=k₁s₁+k₂s₂+ . . . +kₙsₙ (4)

In this equation 4 the value Δs represents the measure of the position error of the passive hydraulic control. The hydraulic pistons are therefore displaced, in sum, out of their desired position by the amount Δs.

Ideally, of course, Δs should always assume the value zero. For this purpose, as described, for example, in the publication DE 299 13 547 U1, an at least temporarily acting hydraulic connection is made between the two volumes V₁ and V₂. In FIG. 2, this hydraulic connection is implemented by way of a throttle valve 4. This makes it possible to exchange small quantities of a hydraulic fluid between the two volumes V₁ and V₂. So that this exchange of hydraulic fluid takes place, on average, in the desired direction, a basic position must be imparted to the overall system by way of other measures.

In the arrangement according to FIG. 2, a basic position is stipulated for the passive hydraulic control by way of the positioning springs 3. This may be defined here, for example, in each case by the middle position of the pistons in both hydraulic cylinders 1. If no external forces act on the piston rods of the hydraulic cylinders 1, then, in the event that the two pistons are not in their middle position, they are pressed into the middle position by the positioning springs 3, while, if appropriate, hydraulic fluid can be displaced from the volume V₁, to the volume V₂, or vice versa, via the throttle valve 4. A position correction (Δs→0) therefore takes place, driven by the positioning springs 3.

Forces acting briefly or dynamically on the piston rods from outside lead only to an insignificant overflow of hydraulic fluid via the throttle valve 4, since the latter has a sufficiently high flow resistance. However, force fractions acting statically on the piston rods from outside give rise, within an increasing period of time to an ever greater overflow of hydraulic fluid via the throttle valve 4 and therefore to a growing position error Δs. Static basic loads on a passive hydraulic control according to FIG. 2 should therefore be avoided, unless the positioning springs 3 have a sufficiently high prestress (a jump in the spring characteristic profile during the passage of the piston through the middle position).

The positioning springs 3 do not, as illustrated in FIG. 2, have to be an integral component of the hydraulic cylinders 1. They may also act on the structural part activated by the hydraulic cylinder 1, without themselves being an integral component of the cylinder. In the examples of the use of passive hydraulic controls which are mentioned further on, they are, inter alia, the secondary springs of rail running gears (bogies) which, by their flexicoil action, impart a basic position to the rail running gears activated by way of the passive hydraulic control.

As is basically reproduced in FIG. 2, a position correction for the passive hydraulic control by way of positioning springs and a throttle valve between the two volumes V₁, and V₂ not only has the disadvantage that statically acting basic loads can be controlled to a limited extent by way of a control of this type, a particular disadvantage is that, for the displacement of a cylinder piston, the force required for bracing all the positioning springs must additionally be applied.

### SUMMARY

At least one embodiment of the invention reduces or even eliminates the disadvantages of a passive hydraulic control with position correction by positioning springs and a throttle valve between the two volumes V₁ and V₂. A passive hydraulic control of the generic type is to be designed such that a position correction is possible even without elements which apply forces counter to the movements of the control, and such that even static basic loads can be transmitted by this passive hydraulic control.

According to at least one embodiment of the invention, in each case when the position error Δs overshoots a positive position error limit +Δs to be defined, or undershoots a negative position error limit −Δs, a connection between the two volumes V₁, and V₂ is made for the purpose of the exchange of hydraulic fluid between the two volumes, in that this connection permits the exchange of hydraulic fluid always only in a direction which is defined as a function of the sign of the position error Δs, in that this connection is made at least when not only one of the defined position error limits +Δs and −Δs is respectively overshot and undershot, but, moreover, all the products of the piston travels s₁ . . . sₙ and the in each case associated proportionality factors k₁ . . . kₙ also have the same sign as the position error Δs, and in that the exchange of hydraulic fluid via this connection is driven by the action of force on the piston rods of the hydraulic cylinders.

### BRIEF DESCRIPTION OF THE DRAWINGS

Further details and advantages of the invention application are explained on the basis of the exemplary example embodiment described below in association with the accompanying drawings, in which:

FIG. 1 illustrates basic principle of a passive hydraulic follow-up control,

FIG. 2 shows a hydraulic connection implemented by way of a throttle valve 4,

FIG. 3 illustrates, by way of example, a passive hydraulic control configured according to an embodiment of the invention, in which a plurality of hydraulic cylinders are connected hydraulically to one another,

The design variant of an embodiment of the invention from FIG. 3 is illustrated once again in FIG. 4, but only with two hydraulic cylinders and with position errors,

FIG. 5 illustrates a passive hydraulic control of the type according to an embodiment of the invention, which has switch contacts,

FIG. 6 illustrates a design variant of an embodiment, functionally comparable to the passive hydraulic control according to FIG. 5,

FIG. 7 shows an identical arrangement of a passive hydraulic control to that of FIG. 6, but the cylinder pistons are not illustrated in their zero position here,

Another piston position for a passive hydraulic control according to FIG. 6 or FIG. 7 is shown in FIG. 8,

FIG. 9 reproduces the passive hydraulic control according to FIG. 6 to FIG. 8 in a somewhat different situation,

FIG. 10 illustrates once again the passive hydraulic control dealt with from FIG. 6 on, but with a plurality of cylinders 1, and

FIG. 11 shows a modified form of the passive hydraulic control known from FIG. 6.

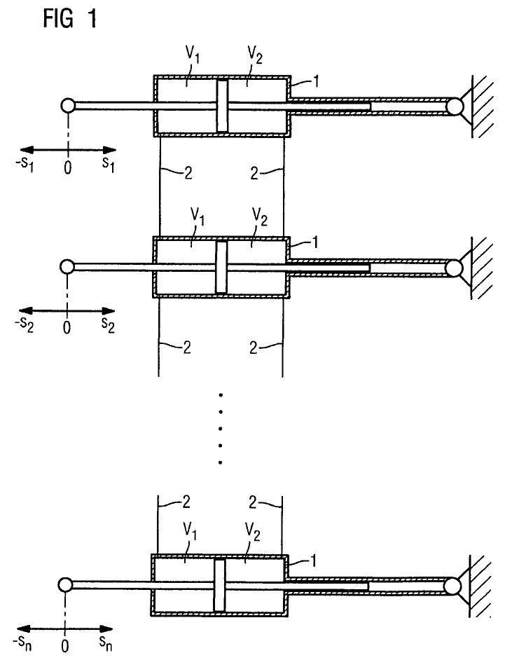

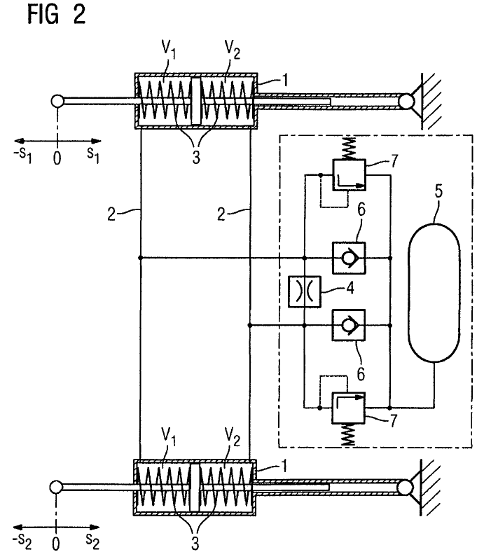

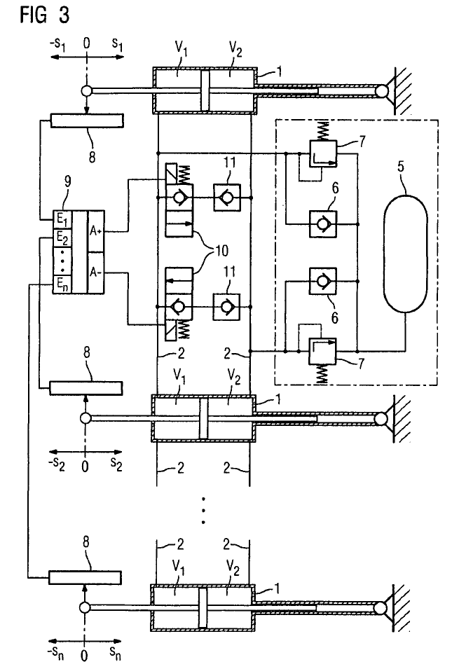

### DETAILED DESCRIPTION OF THE EXAMPLE EMBODIMENTS

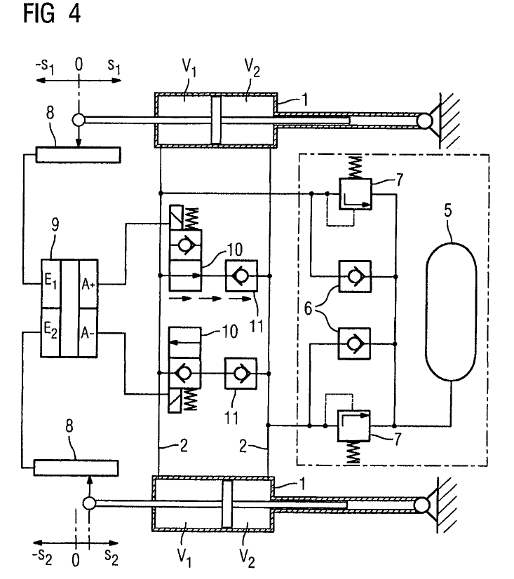

FIG. 3 illustrates, by way of example, a passive hydraulic control configured according to an embodiment of the invention, in which a plurality of hydraulic cylinders 1 are connected hydraulically to one another. The piston travels s₁ . . . sₙ of the cylinders 1 are detected by way of the travel sensors 8. The signals from the travel sensors 8 are supplied to an evaluation and control unit 9. This determines, from the signals of the travel sensors 8, the value for the position error Δs according to equation 4.

Depending on the accuracy requirement to be met by the hydraulic control, the minimum and the maximum value for the position error Δs are to be fixed and are available as reference values in the evaluation and control unit 9. If the Δs value determined by the evaluation and control unit 9 undershoots or overshoots the corresponding limit value, then a signal for activating one of the exchange valves 10 is made available at one of the outputs of the evaluation and control unit 9. The corresponding exchange valve 10 opens, and an exchange of hydraulic fluid from V₁ toward V₂, or vice versa can take place, the possible exchange direction being defined here by the respective nonreturn valve 11.

The design variant of an embodiment of the invention from FIG. 3 is illustrated once again in FIG. 4, but only with two hydraulic cylinders 1 and with position errors. The upper cylinder 1 in FIG. 4 is in the zero position, while the piston of the lower cylinder 1 is displaced toward the positive side by an amount |Δs|. The volume V₁ is consequently too high, while the volume V₂ is too low. Since the piston areas of the two cylinders 1 are of identical size here, both proportionality factors can be set at k₁=k₂=1 according to equation 3, their sign equality being afforded in that the connecting lines 2 between the cylinders 1 are not crossed.

According to equation 4 therefore, a positive value for Δs is determined by the evaluation and control unit 9. If this value is higher than the stipulated maximum value, the evaluation and control unit makes available at its output A+ a signal for activating an exchange valve 10. In FIG. 4, the upper exchange valve 10 is activated, which due to the direction of installation of the associated nonreturn valve 11, makes it possible to exchange hydraulic fluid from V₁ toward V₂, but not vice versa.

In the situation illustrated in FIG. 4, the desired fluid exchange for V₁ toward V₂ and therefore the reduction of the position error occur whenever the higher pressure prevails in the volume V₁, as compared with the volume V₂. This is so when tensile forces act on the piston rods of the cylinders 1. The exchange of the hydraulic fluid between the two volumes is therefore driven by the forces acting on the piston rods. In the event that compressive forces act on the piston rods of the cylinders 1, the pressure in V₂ will be the higher. An exchange of hydraulic fluids does not take place, and the position error remains unchanged.

The function of the position correction according to at least one embodiment of the invention is therefore tied to the fact that forces which change their direction of action at least for short time intervals act on the piston rods, and this has to take place with sufficient frequency. This restriction with regard to the applicability of the position correction according to the invention is counteracted by the advantage that its function is not tied to a supply of external energy for the exchange of hydraulic fluid between the two volumes.

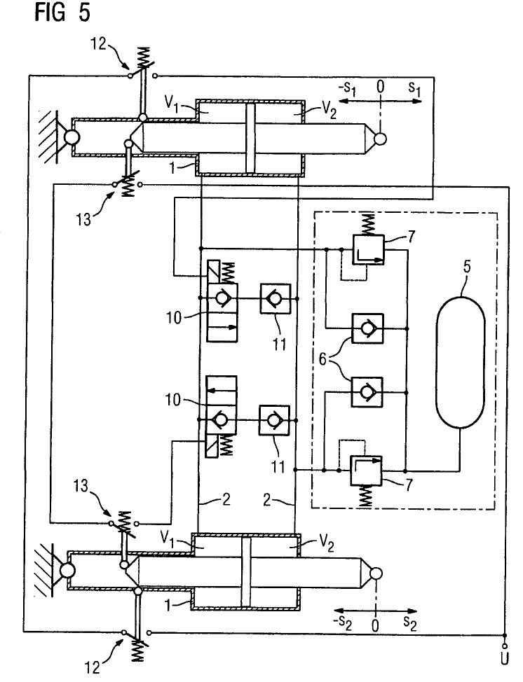

FIG. 5 illustrates a passive hydraulic control of the type according to an embodiment of the invention, which, instead of the travel sensors 8 from FIG. 3 or FIG. 4, has switch contacts 12 and 13. These switch contacts 12 and 13 signal the overshooting of the zero position by the cylinder pistons in the positive or in the negative travel direction. Since there is no quantitative travel information available here, but only qualitative travel information, the evaluation of the signals can be implemented more simply. By the switch contacts 12 and 13 being wired up appropriately, an AND operation to link the travel signals is generated. Thus, if it applies to all the cylinders 1 involved in the passive hydraulic control that the product of their piston travel sₙ and the associated proportionality factor kₙ is positive, a hydraulic connection is made by way of the exchange valve 10 which, in conjunction with a nonreturn valve 11, makes it possible to exchange hydraulic fluid from the volume V₁ to the volume V₂. If the products of the piston travels sₙ and the associated proportionality factors kₙ are all negative, the exchange of hydraulic fluid becomes possible in the opposite direction from the volume V₂ to the volume V₁.

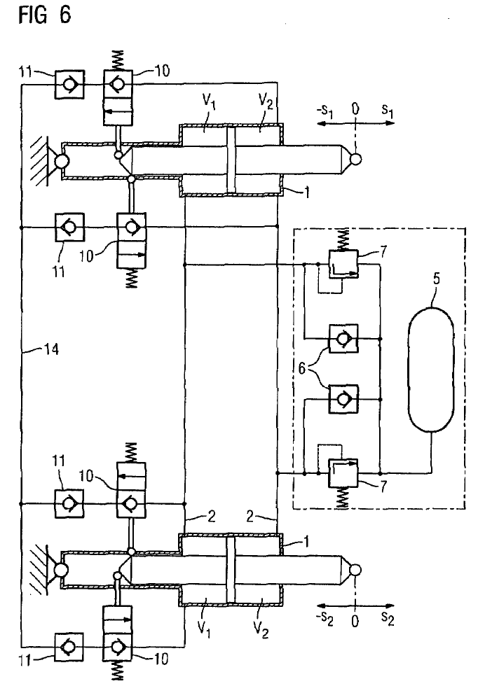

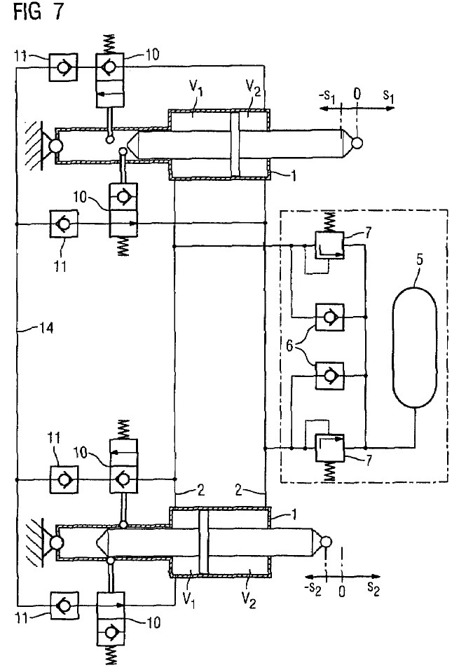

The design variant of an embodiment according to FIG. 6 is functionally comparable to the passive hydraulic control according to FIG. 5. Here, the exchange valves 10 are not activated via electrical auxiliary energy, but directly by the piston rods of the cylinders 1, each cylinder 1 being assigned corresponding exchange valves 10 and nonreturn valves 11. By way of the exchange line 14, the linkage of the travel information of the cylinder piston rods, which is reflected in the switching positions of the exchange valves 10, takes place.

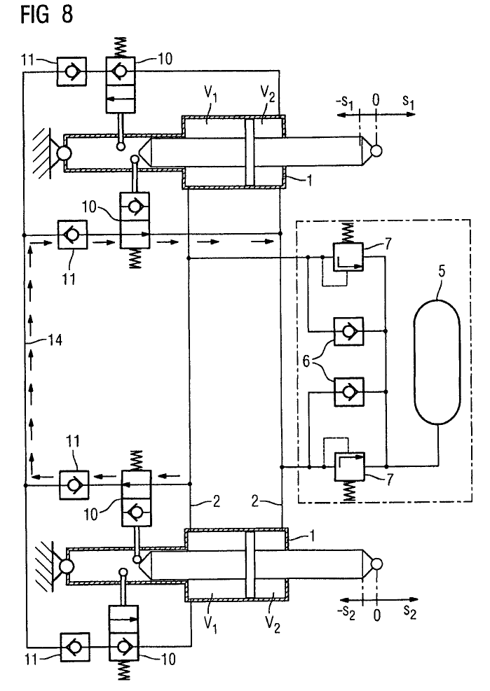

FIG. 7 shows an identical arrangement of a passive hydraulic control to that of FIG. 6, but the cylinder pistons are not illustrated in their zero position here. The piston of one cylinder 1 is displaced in the positive travel direction and the other cylinder piston in the negative travel direction, but both by the same amount. Since, for example, piston areas of identical size are assumed on both cylinders 1 again here, and the connecting lines 2 are not crossed, k₁=k₂=1 applies once more to the proportionality factors. According to equation 4, therefore, the position error amounts to Δs=0. An exchange of hydraulic fluid between the two volumes is therefore neither necessary nor permissible. As may be gathered from FIG. 7, this is ensured by the present direction of action of the nonreturn valves 11, which are assigned in each case to the cleared exchange valves 10.

Another piston position for a passive hydraulic control according to FIG. 6 or FIG. 7 is shown in FIG. 8. Here, the pistons of the two cylinders 1 are displaced in the positive travel direction. According to equation 4, here, a value different from zero is obtained for the position error Δs (since k₁=k₂=1 applies again, Δs>0). An exchange of hydraulic fluid from the volume V₁ to the volume V₂ is therefore required for the position correction. The valve position illustrated in FIG. 8 makes this possible for the situation where a higher pressure prevails in the volume V₁ than in the volume V₂. In FIG. 8, the travel of the hydraulic fluid via the exchange line 14 is identified by corresponding arrows.

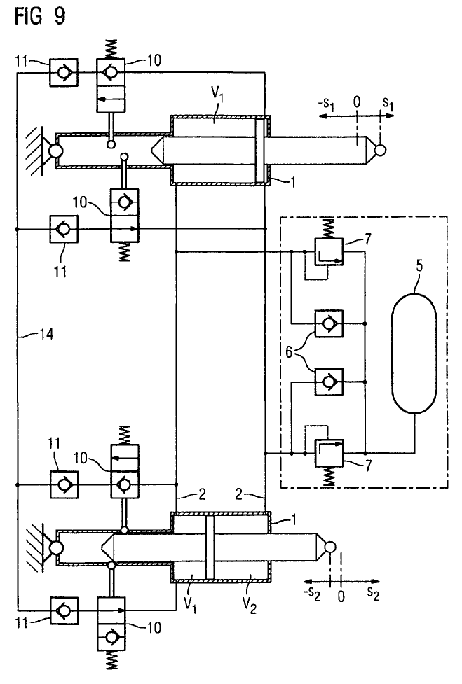

FIG. 9 reproduces the passive hydraulic control according to FIG. 6 to FIG. 8 in a somewhat different situation. In this illustration, the piston of the upper cylinder 1 is displaced in the positive travel direction but the piston of the lower cylinder 1 is displaced in the negative travel direction. In contrast to FIG. 7, however, the piston travels on the two cylinders 1 are also different in amount. A position error Δs different from zero therefore may be determined according to equation 4. Since, for the piston positions reproduced in FIG. 9, and on the assumption k₁=k₂=1, this position error is positive, an exchange of hydraulic fluid from the volume V₁ to the volume V₂ is required for a position correction, but is not possible for the piston positions illustrated. The position correction can take place only when piston movements have taken place which have generated piston positions comparable to those according to FIG. 8, that is to say when both pistons are displaced in the positive travel direction.

The exchange of hydraulic fluid from the volume V₁ to the volume V₂, or else vice versa, is therefore possible as long as one of the defined position error limits +Δs and −Δs is respectively overshot or undershot, and, moreover, all the products of the piston travels s₁ . . . sₙ and the in each case associated proportionality factors k₁ . . . kₙ also have the same sign as the position error Δs. This restrictive condition for the functioning of the position correction is generated in that, in the passive hydraulic controls, as they are illustrated from FIG. 5 on, the travel signals for the piston travels are reduced to establishing whether the respective piston is on one side of the zero position or the other. In each case, therefore, only the sign of the piston travels is “known”, and this only in the event that the switching thresholds of the switch contacts 12 and 13 in FIG. 5 or of the exchange valves 10 in the following figures are overshot. Since, therefore, the actual amounts of the piston travels in the passive hydraulic controls such as are illustrated from FIG. 5 on, are not used for the functioning of the position correction, equation 4 gives evidence of the sign of the position error Δs only when all the products k₁·s₁; k₂·s₂ . . . kₙ·sₙ have the same sign. The sum of these products, that is to say the position error Δs, then has the same sign as each of the products.

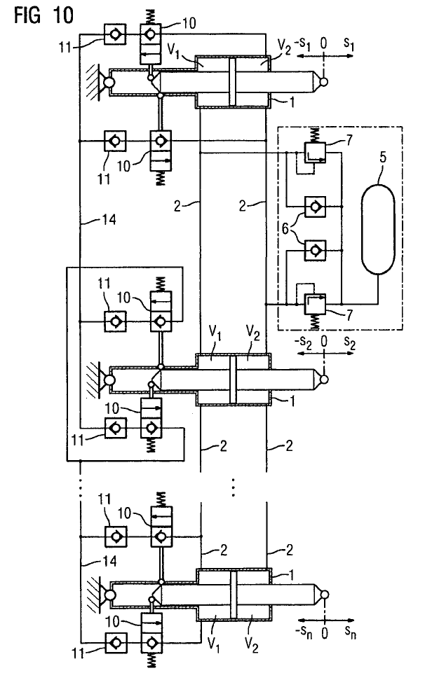

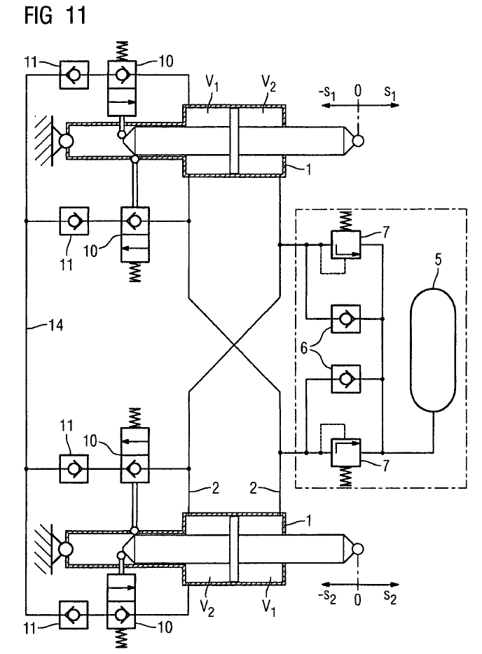

FIG. 10 illustrates once again the passive hydraulic control dealt with from FIG. 6 on, but with a plurality of cylinders 1. FIG. 11, too, shows a modified form of the passive hydraulic control known from FIG. 6. Here, the connecting lines 2 between the hydraulic cylinders 1 are crossed. The result of this is that proportionality factors change their sign after the crossing. With the piston areas of the two cylinders 1 being identical, equation 4 then assumes, for FIG. 11, the following form:

Δs=s₁−s₂.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A passive hydraulic control, comprising:
volumes V₁ and V₂, on two sides of pistons of two or more hydraulic cylinders, connected hydraulically to one another, such that a displacement of the pistons in one of the cylinders results in a displacement of the piston in at least one of the other cylinders, wherein a sum of the piston travels is s₁; s₂ . . . sₙ, the signs of which are dependent on whether connecting lines between the hydraulic cylinders are crossed or not, wherein for all the cylinders s=k₁s₁+k₂s₂+ . . . +kₙsₙ is ideally always zero, the proportionality factors k₁, k₂ . . . kₙ being dependent on the reciprocal of the piston areas of the cylinders, and, in the event of the occurrence of a deviation of the sum of the piston travels s from zero by more than a positive position error limit +Δs to be defined or a negative position error limit −Δs, this is corrected by a connection between the two volumes V₁ and V₂ being made for the purpose of the exchange of hydraulic fluid between the two volumes, the connection permitting the exchange of hydraulic fluid always only in a direction which is defined as a function of the sign of the position errors Δs, wherein the exchange of hydraulic fluid via the connection is driven by the action of force on the piston rods of the hydraulic cylinders, and wherein the connection is made when not only one of the defined position error limits +Δs and −Δs is respectively overshot or undershot, but, moreover, all the products of the piston travels s₁ . . . sₙ and the associated proportionality factors k₁ . . . kₙ also have the same sign as the position error Δs, if the connecting lines between the hydraulic cylinders are not crossed, and have a different sign from the position error Δs, if the connecting lines are crossed.

2-4. (canceled)

5. The passive hydraulic follow-up control as claimed in claim 1, wherein positions of the cylinder pistons are determined by way of electrical/electronic travel sensors and an electrical/electronic evaluation and control unit, on the basis of the determined positions, controls hydraulic valves such that, in the event of a position error, these permit an exchange of hydraulic fluid either only from the volume V₁ to the volume V₂ or only vice versa, depending on the direction of the position error.

6. The passive hydraulic follow-up control as claimed in claim 1, wherein, by way of electrical/electronic switching elements, it is signaled for each hydraulic cylinder whether its cylinder piston is located on one side of its zero position or the other, and wherein, in the event that all the cylinder pistons are displaced out of their zero position toward the same volume side, by the switching elements of all the cylinders being appropriately wired up to one another, hydraulic valves are activated such that these permit an exchange of hydraulic fluid either only from the volume V₁ to the volume V₂ or only vice versa, depending on the direction of the position error.

7. The passive hydraulic follow-up control as claimed in claim 1, wherein each hydraulic cylinder is assigned hydraulic switching valves, which are actuated directly or indirectly by the respective cylinder piston, in such a way that they change their switching state as a function of whether the cylinder piston is located on one side of its zero position or the other, and wherein, in the event that all the cylinder pistons are displaced out of their zero position toward the same volume side, by the switching valves of all the cylinders being appropriately wired up hydraulically to one another, an exchange of hydraulic fluid either only from the volume V₁ to the volume V₂ or only vice versa, depending on the direction of the position error, is permitted by these valves.
